(19) United States
(12) Patent Application Publication
(10) Pub. No.: US 2019/0328161 A1
(43) Pub. Date: Oct. 31, 2019

(54) Multi-Functional Mirror Having Novel Installation Structure

(71) Applicant: Foshan Eterna Lighting Co., Ltd., Guangdong (CN)

(72) Inventor: Yongli Wei, Guangdong (CN)

(73) Assignee: Foshan Eterna Lighting Co., Ltd., Guangdong (CN)

(21) Appl. No.: 16/083,996

(22) PCT Filed: Jul. 12, 2017
(86) PCT No.: PCT/CN2017/092558

§ 371 Date: Sep. 11, 2018

(30) Foreign Application Priority Data
Dec. 27, 2016 (CN) 201621445325.1

(51) Int. Cl. A47G 1/06; F21V 23/00; F21V 31/00; A47G 1/02; A47G 1/17

(52) U.S. Cl. CPC A47G 1/0622; F21V 23/003; F21Y 2115/10; A47G 1/02; A47G 1/17; F21V 31/005

(57) ABSTRACT

A multi-functional mirror includes a glass mirror and a bottom case. An inverted V-shaped hanging board is fixed to the glass mirror. A V-shaped hanger is fixed to the bottom case. The hanging board engages with the hanger such that the glass mirror is hung above the bottom case. Moreover, electronic components are concealed after completion of assembly.

### TECHNICAL FIELD

The disclosure relates to a multi-functional mirror having a novel installation structure, belonging to the field of mirror technology.

### BACKGROUND

With the improvement of people's living standard and the development of technology, there are many additional functions for the mirror used in life, such as a built-in fluorescent tube or an LED light source, and a supporting circuit component; a built-in TV or a display; a built-in electronic anti-fog device; and a built-in sensor switch, a dimmer component, a clock, etc. At present, the structure of some existing multi-functional mirrors on the market is designed to stick functional fittings such as a hanging part, a light source and an electric appliance component to the back of the mirror by adhesive or double-faced adhesive tape. By means of a hanging part, an aluminum frame with a hanging hole or a frame with an added hanging hole, the mirror is then hanged on a screw locked on a wall, so that the mirror is hanged to the wall.

The multi-functional mirror with the above-mention structures has the problems in that: 1. difficult production is due to several-times movements of the glass mirror during the production process, which is easy to cause the glass mirror to be scratched and smashed; 2. some exposed components are not beautiful enough; 3. regarding difficult installation and maintenance, firstly the size and position of installation need to be accurately measured while installing, secondly the hanging hole on the glass mirror needs to be precisely aligned to a screw as the glass mirror is hanging to the wall, even it needs to be operated by two people in the case of the glass mirror is large, additionally, the whole set of product should be replaced if there is a problem in use of the multi-functional mirror, which leads to the waste, and the whole set of products need to be removed and are replaced by better electronic components if an electronic component such as the light source or the circuit component have problem, which wastes time and energy; and 4. electronic components in use cause safety risk if the mirror is installed in the bathroom with not good water vapor resistance and moisture resistance.

Therefore, it is necessary to design a multi-functional mirror having a novel installation structure to overcome the technical problems above.

### SUMMARY

The disclosure is intended to provide a multi-functional mirror. The multi-functional mirror is simple and time-saving in installation, and easy to maintain, and has water resistance and moisture resistance during use. The electronic component is concealed after installation, so that multi-functional mirror is safe and beautiful.

In order to solve the technical problems above, it provides in the technical solution of the disclosure a multi-functional mirror having a novel installation structure comprising a glass mirror and a bottom case, wherein an inverted V-shaped hanging board is fixed to the glass mirror, a V-shaped hanger is fixed to the bottom case, and the hanging board engages with the hanger, such that the glass mirror is hung above the bottom case.

Further, two hanging boards are fixed to the glass mirror, the two hanging boards are arranged up and down, two hangers are fixed to the bottom case, and the two hanging boards engage with the two hangers.

Further, the hanging board is fixed to the back of the glass mirror by a structural adhesive.

Further, a space is formed between the glass mirror and the bottom case, a light source is respectively installed in the space above the bottom case, and the glass mirror is provided with a sanding area for light transmission.

Further, the light source is an LED light bar, an LED driver is installed in the space above the bottom case, the LED light bar is electrically connected to the LED driver, the LED driver is electrically connected to a power line, and the LED light bar corresponds to the sanding area.

Further, the profile of the sanding area is a square, a rectangle or a circle, and the LED light bars are connected end to end in a square, a rectangle, or a circle.

Further, the bottom case is provided with a waterproof strip around, and the waterproof strip is attached to the glass mirror.

Further, the bottom case is provided with a screw hole for fixing the bottom case.

Further, the glass mirror is a circle, a square, a rectangle or an ellipse.

The disclosure has the beneficial effects that: regarding the multi-functional mirror of the disclosure, the two parts of the glass mirror thereof and the bottom case are independent from each other, and the hanging board engages with the hanger to hang the glass mirror above the bottom case. The bottom case is fixed to the wall while installing, the glass mirror can be hung by a handlebar, the glass mirror can be removed by the handlebar while disassembling, and the disassembly and assembly are simple and easy to operate, time-saving and labor-saving, and convenient in maintenance; after installation, the electronic component is built in, and the overall profile is beautiful and safe; and the bottom case is provided with the waterproof strip, and after installation, the glass mirror is pressed tightly to the waterproof strip on the bottom case, which plays a role of moisture resistance and water vapor resistance.

### BRIEF DESCRIPTION OF THE DRAWINGS

FIG. 1 is a first exploded view of a multi-functional mirror in a first embodiment according to the disclosure.

FIG. 2 is a second exploded view of the multi-functional mirror in a first embodiment according to the disclosure.

FIG. 3 is a first exploded view of the multi-functional mirror in a second embodiment according to the disclosure.

FIG. 4 is a second exploded view of the multi-functional mirror in the second embodiment according to the disclosure.

Regarding the Reference Numerals:

1 refers to glass mirror, 2 refers to bottom case, 3 refers to waterproof strip, 4 refers to LED light bar, 5 refers to power lead, 6 refers to LED driver, and 7 refers to waterproof sleeve 7;

11 refers to sanding area, and 12 refers to hanging board; and

21 refers to hanger, and 22 refers to screw hole.

### DETAILED DESCRIPTION

The technical solutions in the embodiments according to the disclosure will be clearly and perfectly described hereinafter with reference to the drawings in the disclosure, and obviously, the described embodiments are merely several embodiments instead of all embodiments. On the basis of the embodiments in the disclosure, all other embodiments envisaged by those skilled in the art without creative works fall in the protection scope of the disclosure.

### The First Embodiment

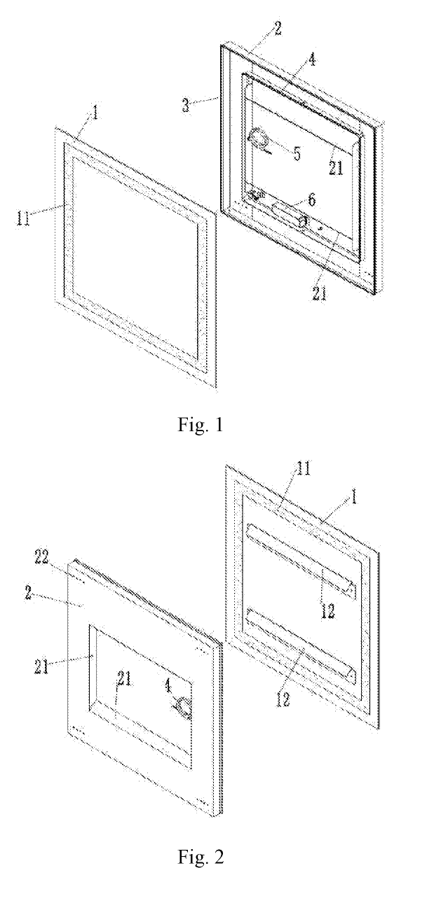

FIG. 1 and FIG. 2 show a multi-functional mirror having a novel installation structure of the first embodiment comprises a glass mirror 1 and a bottom case 2. The configuration of the glass mirror 1 is a square, and can also be designed into other shapes. The glass mirror 1 is provided with a square sanding area 11 for light transmission. The back of the glass mirror 1 is fixed with two inverted V-shaped hanging boards 12 through structural adhesive (there can be one hanging board 12, if necessary), the two hanging boards 12 are arranged up and down. Two V-shaped hangers 21 are fixed in the bottom case 2 (there can be one hanger 21, if necessary). The hanging board 12 engages with the hanger 21 to hang the glass mirror 1 above the bottom case 2. The glass mirror 1 forms a space with the bottom case 2. A light source is respectively installed in the space above the bottom case 2. The light source is designed as an LED light bar 4 with end to end connection in a square. The LED light bar 4 corresponds to the sanding area 11. An LED driver 6 is fixed in the space above the bottom case 2 by a screw, the LED light bar 4 is electrically connected to the LED driver 6, and the LED driver 6 is electrically connected to the power lead 5.

In a preferred design solution, the bottom case 2 is provided with a waterproof strip 3 around. The waterproof strip 3 is attached to the glass mirror 1. The waterproof strip 3 plays a role of moisture resistance and water vapor resistance. A screw hole 22 for fixing the bottom case 2 is processed in the bottom case 2.

### The Second Embodiment

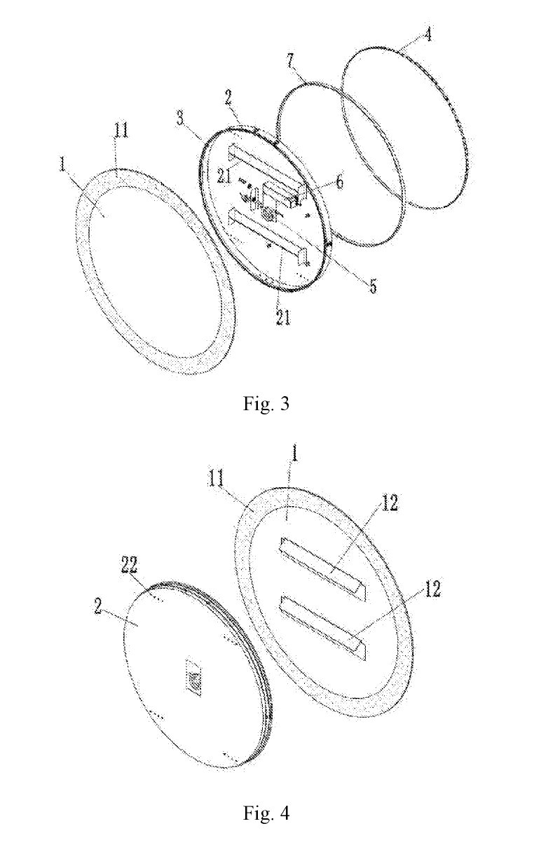

FIG. 3 and FIG. 4 show a multi-functional mirror having a novel installation structure of the second embodiment. The multi-functional mirror of the second embodiment differs from that of the first embodiment in that: the configuration of the glass mirror 1 is a circle, and the configuration of the bottom case 2 is a circle; and the sanding area 11 is a circle, the LED light bars 4 are connected end to end in a circle, the LED light bar 4 is installed in the waterproof sleeve 7 capable of light transmission, the waterproof sleeve 7 is sleeved on the bottom case 2, and the waterproof sleeve 7 and the sanding area 11 correspond to each other.

The bottom case 2 is firstly leaned against the wall to confirm the installation position while installing, the position of the screw hole is marked, and then the bottom case 2 is removed. The hole is drilled in the wall, a rubber plug is knocked in, then the bottom case 2 is fixed to the wall by the screw, the power lead 5 is connected, and finally the glass mirror 1 is hung. Slight adjustment is available, so that the LED light bar 4 corresponds to the sanding area 11. At the same time, the back of the glass mirror 1 is tightly attached and pressed to the waterproof strip 3 on the bottom case 2 to realize moisture resistance and water vapor resistance, and the electronic component in the bottom case 2 is protected. If the glass mirror 1 is damaged in use, only the glass mirror 1 needs to be removed, and a glass mirror of the same specification is installed. If the electronic component is damaged, the glass mirror 1 is firstly removed and put aside, the corresponding electronic component is replaced, and then the glass mirror is hung.

Regarding the multi-functional mirror of the disclosure, the two parts of the glass mirror and the bottom case are independent from each other, the electronic component parts are all installed in the bottom case, and the bottom case part is movable in production mainly, so as to avoid the glass mirror from scratching and damaging. The bottom case is fixed to the wall during installation, the glass mirror is hung, and the installation is simple and easy to operate. The electronic component is built in after installation, which is not visible exteriorly, and is beautiful and generous. The back of the glass mirror is pressed and attached to the waterproof strip on the bottom case, so as to have moisture resistance and water vapor resistance. Since the glass mirror is easy to assemble and disassemble, the replacement of each part in use is easy and simple, the maintenance is convenient, time-saving and labor-saving, the material is saved, and waste is avoided.

The above are only the preferred embodiments of the disclosure, and is not intended to limit the disclosure. Any modifications, equivalent substitutions, improvements, etc. based on the context and principle of the disclosure shall fall into the protection scope.

1. A multi-functional mirror having a novel installation structure, comprising a glass mirror and a bottom case, wherein an inverted V-shaped hanging board is fixed to the glass mirror, a V-shaped hanger is fixed to the bottom case, and the hanging board engages with the hanger, such that the glass mirror is hung above the bottom case.

2. The multi-functional mirror having a novel installation structure according to claim 1, wherein two hanging boards are fixed to the glass mirror, the two hanging boards are arranged up and down, two hangers are fixed to the bottom case, and the two hanging boards engage with the two hangers.

3. The multi-functional mirror having a novel installation structure according to claim 1, wherein the hanging board is fixed to the back of the glass mirror by a structural adhesive.

4. The multi-functional mirror having a novel installation structure according to claim 2, wherein the hanging board is fixed to the back of the glass mirror by a structural adhesive.

5. (canceled)

6. The multi-functional mirror having a novel installation structure according to claim 5, wherein the light source is an LED light bar, an LED driver is installed in the space above the bottom case, the LED light bar is electrically connected to the LED driver, the LED driver is electrically connected to a power line, and the LED light bar corresponds to the sanding area.

7. The multi-functional mirror having a novel installation structure according to claim 6, wherein the profile of the sanding area is a square, a rectangle or a circle, and the LED light bars are connected end to end in a square, a rectangle, or a circle.

8. The multi-functional mirror having a novel installation structure according to claim 1, wherein the bottom case is provided with a waterproof strip on the periphery, and the waterproof strip is attached to the glass mirror.

9. The multi-functional mirror having a novel installation structure according to claim 1, wherein the bottom case is provided with a screw hole for fixing the bottom case.

10. The multi-functional mirror having a novel installation structure according to claim 1, wherein the shape of the glass mirror is a circle, a square, a rectangle or an ellipse.
